(19) United States
(12) Patent Application Publication
(10) Pub. No.: US 2016/0255780 A1
(43) Pub. Date: Sep. 8, 2016

(54) UNDERGROUND IRRIGATION SYSTEM

(71) Applicant: James Lockshaw, Paso Robles, CA (US)

(72) Inventor: James Lockshaw, Paso Robles, CA (US)

(21) Appl. No.: 14/638,241

(22) Filed: Mar. 4, 2015

(51) Int. Cl. A01G 25/06; A01G 25/02; A01G 25/16

(52) U.S. Cl. CPC A01G 25/06; A01G 25/16; A01G 25/02

(57) ABSTRACT

Systems and methods to supply water to plants in a direct and efficient manner by employing aboveground plumbing to individual plants, but not allowing the water to be dispersed aboveground. The water is directed to an underground container or cartridge assembly that dispenses the water through a dissipater (e.g., wick) into the surrounding soil. The cartridge assembly of the underground irrigation system may be installed in-line with supply water lines and deep enough that the dispersed water does not return near the surface which allows for working the soil over the underground irrigation system. Each of the cartridge assemblies of the underground irrigation system may be installed in line between two plants in a narrow trench at a depth of approximately 6 to 12 inches (e.g., 8 inches), so that each end of each cartridge assembly supplies water to one side of one of the two plants.

### BACKGROUND

1. Technical Field

The present disclosure generally relates to irrigation systems, methods and articles.

2. Description of the Related Art

Many areas in the world are currently suffering from a limited water supply. In the state of California, for example, the majority of the available fresh water is used for irrigation to grow fruits and vegetables for the United States and other nations' food supplies. The water needs for these purposes are of great importance, especially during times of drought.

Drip irrigation, also known as trickle irrigation or localized irrigation, is an irrigation method that saves water and fertilizer by allowing water to drip slowly to the soil surface through a network of valves, pipes, tubing, and water emitting devices. Components used in drip irrigation may include pump or pressurized water source, water filter(s) or filtration systems, “fertigation” systems, backflow prevention device, pressure regulator, main line, control valves and safety valves, smaller diameter polytube, poly fittings and accessories, and emitting devices at plants (emitter or dripper, micro spray head, inline dripper or inline drip tube). An emitter, also referred to as a dripper, is used to transfer water from a pipe or tube to the area that is to be irrigated. In many emitters, flow will vary with pressure, while some emitters are pressure compensating.

Properly designed, installed, and managed, drip irrigation systems may help achieve water conservation by reducing evaporation and deep drainage when compared to other types of irrigation systems, such as sprinklers, since water can be more precisely applied to the plant roots. Additionally, drip irrigation can eliminate many diseases that are spread through water contact with the foliage. Finally, in regions where water supplies are severely limited, there may be no actual water savings, but rather simply an increase in production while using the same amount of water. In very arid regions or on sandy soils, the preferred method is to apply the irrigation water as slowly as possible.

Subsurface or underground drip irrigation applies water directly to the crop root zone using buried tubing (e.g., polyethylene tubing), also known as a drip line, dripper line, or drip tape. Drip lines come in various diameters and thicknesses to maintain acceptable irrigation uniformity for different field sizes.

Subsurface drip lines include small holes called emitters that are spaced along the length of the drip line. During irrigation, pressure forces the water out of the emitters and into the soil drop by drop. The amount of water that can be delivered through a subsurface drip system depends on drip line diameter and spacing, emitter spacing, emitter size, emitter design, and operating pressure. A variety of drip lines are available from different manufacturers to accommodate specific design requirements for different soils, crops and weather conditions.

One of the main advantages of subsurface irrigation methods over other irrigation methods is that subsurface irrigation applies water very efficiently, wetting a fraction of the soil volume compared to other irrigation methods. Additionally, since the drip lines are buried, the soil surface stays dry, which reduces or eliminates water loss due to evaporation and runoff. Thus, subsurface systems potentially save water needed for irrigation systems.

Additionally, having the irrigation system underground and keeping the soil surface dry allows farm equipment to enter the field, even during irrigation events. In arid areas, the dry soil surface may also reduce the potential for the growth of shallow rooted weeds, mold, etc.

One of the main disadvantages of subsurface irrigation systems is their high initial investment cost. This cost can especially be prohibitive in instances where a field with existing plants (e.g., grapevines) has already been equipped with an aboveground drip irrigation system. Additionally, installing a subsurface irrigation system requires significant labor and, in the case of fields with existing crops, deep boring near the crops during installation of a subsurface irrigation system may cause unacceptable damage to the root systems of the crops.

### BRIEF SUMMARY

An underground irrigation system for irrigating plants in a row of plants may be summarized as including a plurality of cartridge assemblies, each of the cartridge assemblies including: a cartridge body positionable below a surface of soil between two adjacent plants in the row of plants, the cartridge body having a sidewall that includes a plurality of perforations that extend between an inner surface of the sidewall to an outer surface of the sidewall, the cartridge body further includes a water supply aperture; a feed tube having a first end and a second end, the first end of the feed tube coupleable to an aboveground irrigation system to receive water from the aboveground irrigation system, the second end of the feed tube coupled to the water supply aperture of the cartridge body; and a fluid dissipation layer having an inner surface and an outer surface, the inner surface of the fluid dissipation layer positioned adjacent to and surrounding the outer surface of the sidewall of the cartridge body and in fluid communication with the perforations in the sidewall of the cartridge body.

The underground irrigation system may further include a wrapping material wound around the fluid dissipation layer to secure the fluid dissipation layer to the cartridge body. The wrapping material may include fiberglass roving. The wrapping material may include one or more strands of material wound around the fluid dissipation layer in one of a single helix pattern or a double helix pattern. The first end of the feed tube may be coupleable to an emitter of the aboveground irrigation system. The cartridge body may include a first end and a second end opposite the first end, and the water supply aperture may be positioned proximate one of the first end or the second end. The cartridge body may include a cylindrically shaped polyvinyl chloride (PVC) pipe. The cartridge body may be positionable at a depth of between 6 inches and 12 inches below the surface of the soil. The cartridge body may have a length of between 12 inches and 48 inches. At least some of the perforations in the sidewall of the cartridge body may include slots. The fluid dissipation layer may include a fiberglass mat. The first end of the feed tube may be selectively coupleable to the aboveground irrigation system via a non-fluid tight coupling.

A method of converting an aboveground irrigation system to an underground irrigation system may include providing a plurality of cartridge assemblies, each of the cartridge assemblies including: a cartridge body having a sidewall that includes a plurality of perforations that extend between an inner surface of the sidewall to an outer surface of the sidewall, the cartridge body further includes a water supply aperture; a feed tube having a first end and a second end, the second end of the feed tube coupled to the water supply aperture of the cartridge body; a fluid dissipation layer having an inner surface and an outer surface, the inner surface of the fluid dissipation layer positioned adjacent to and surrounding the outer surface of the sidewall of the cartridge body and in fluid communication with the perforations in the sidewall of the cartridge body; and a wrapping material wound around the fluid dissipation layer to secure the fluid dissipation layer to the cartridge body; positioning a plurality of cartridge bodies in alignment with a row of plants at a determined depth below a surface of soil, each of the cartridge bodies disposed between a respective pair of adjacent plants in the row of plants; and coupling the first end of the feed tube of each respective cartridge body to the aboveground irrigation system to receive water from the aboveground irrigation system.

The plurality of cartridge bodies in alignment with the row of plants may include positioning each of the cartridge bodies between a respective pair of adjacent plants in the row of plants equidistant from each of the pair of adjacent plants.

The method may further include digging a plurality of trenches in the soil in alignment with the row of plants at the determined depth below the surface of the soil, each of the trenches associated with one of the plurality of cartridge bodies and positioned between a respective pair of adjacent plants in the row of plants. Digging a plurality of trenches may include digging a plurality of trenches that each have a depth of between 6 inches and 12 inches.

The method may further include fastening a portion of the feed tube to a support. Coupling the first end of the feed tube to the aboveground irrigation system may include coupling the first end of the feed tube to the aboveground irrigation system via a non-fluid tight coupling.

An underground irrigation system for irrigating two adjacent plants in a row of plants may be summarized as including a cartridge body positionable below a surface of soil between the two adjacent plants in the row of plants, the cartridge body having a sidewall that includes a plurality of perforations that extend between an inner surface of the sidewall to an outer surface of the sidewall; a feed tube having a first end and a second end, the first end of the feed tube coupleable to an emitter of an aboveground drip irrigation system to receive water from the emitter, the second end of the feed tube fluidly coupled to the cartridge body; a fluid dissipation layer having an inner surface and an outer surface, the inner surface of the fluid dissipation layer surrounding at least a portion of the outer surface of the sidewall of the cartridge body; and a wrapping material wound around the fluid dissipation layer to secure the fluid dissipation layer to the cartridge body. The wrapping material may include fiberglass roving. The wrapping material may include one or more strands of material wound around the fluid dissipation layer in one of a single helix pattern or a double helix pattern. The cartridge body may have a length of between 12 inches and 48 inches. The fluid dissipation layer may include a fiberglass mat. The first end of the feed tube may be selectively coupleable to the aboveground irrigation system via a non-fluid tight coupling.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of an installed underground irrigation system, according to one illustrated embodiment.

FIG. 2 is an isometric view of a cartridge assembly of the underground irrigation system of FIG. 1, according to one illustrated embodiment.

FIG. 3 is an exploded isometric view of the cartridge assembly of FIG. 2, according to one illustrated embodiment.

FIG. 4 is an elevational view of a portion of the installed underground irrigation system of FIG. 1, according to one illustrated embodiment.

FIG. 5 is a schematic diagram that shows an example layout for the cartridge assemblies of the underground irrigation system of FIG. 1, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with power electronics have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the embodiments.

Embodiments of the present disclosure are directed to systems and methods to supply water to desired plants in a direct and efficient manner by employing some of the principles of aboveground drip irrigation, such as the aboveground plumbing to individual plants, but not allowing the water to be dispersed aboveground. Rather, the water is directed to an underground container or cartridge that dispenses the water through a dissipater (e.g., wick) into the surrounding soil. The cartridge assemblies of the underground irrigation system discussed herein may be installed in line with supply water lines and deep enough that the dispersed water does not return near the surface which allows for working the soil over the underground irrigation system. For example, in some applications the cartridge assemblies of the underground irrigation system may be installed in a narrow trench at a depth of approximately 6 to 12 inches (e.g., 8 inches). The systems and methods of the present disclosure may be used to converting existing aboveground irrigation systems into underground irrigation systems.

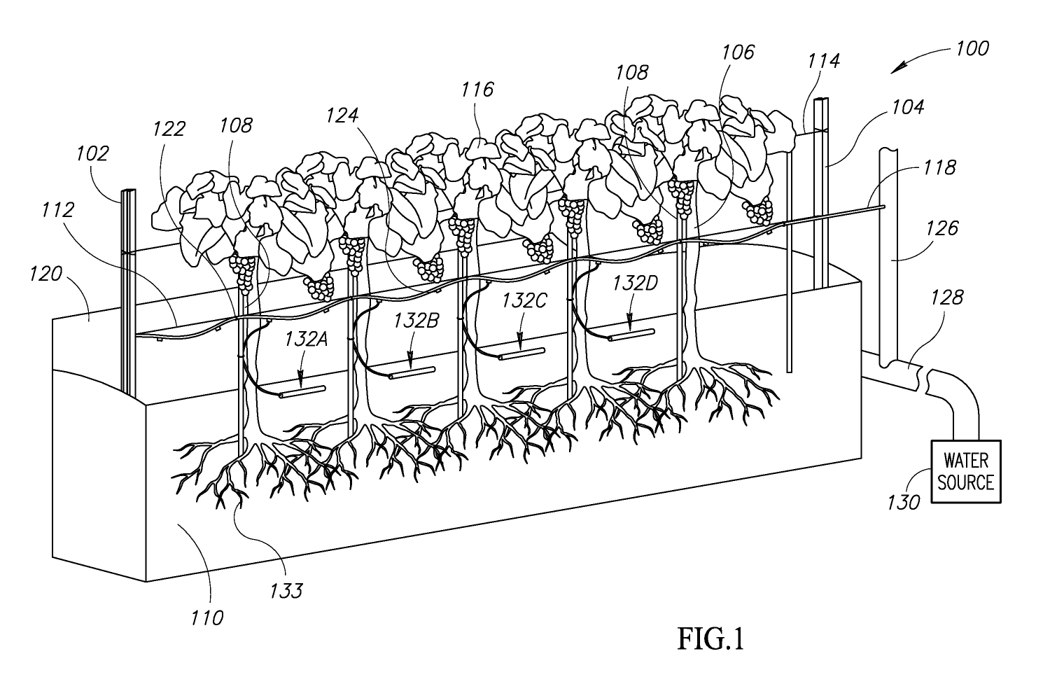

FIG. 1 illustrates an environment in which an implementation of an underground irrigation system 100 of the present disclosure may be employed. In FIG. 1, the underground irrigation system 100 is shown in a vineyard for growing grapes, although it should be appreciated that the present disclosure applies equally to other types of fields and plants. The underground irrigation system 100 includes some of the components of a conventional aboveground drip irrigation system, such that existing aboveground drip irrigation systems may be easily converted into the underground irrigation system 100.

The underground irrigation system 100 includes a first main post 102 spaced apart from a second main post 104 by a plurality of grapevines 106. Each of the grapevines 106 is supported by a stake 108 driven into soil 110. The main posts 102 and 104 may each be eight foot, 4″×4″ wood posts, for example, driven into the soil 110 to be supported vertically therein. It should be understood that although only two main posts 102 and 104 are shown, in practice any number of main posts may be aligned in multiple rows (e.g., spaced apart by several vines) when used in fields, orchards, vineyards, etc. The main posts 102 and 104 may be formed from any suitable material, such as wood or steel.

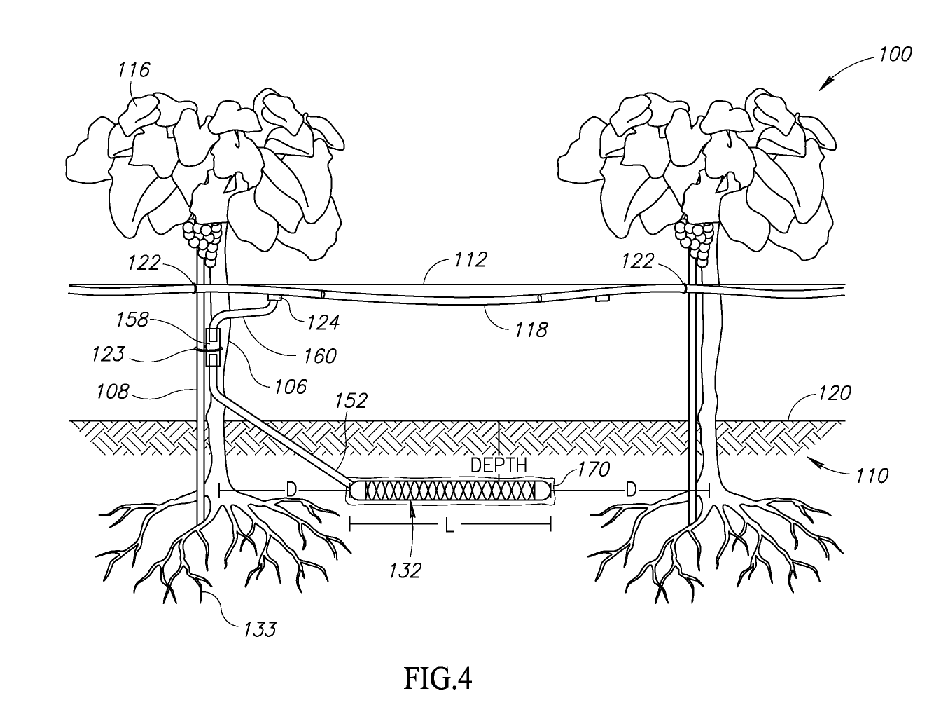

In the illustrated example, the main posts 102 and 104 support and tension a lower drip line support wire 112 and an upper fruiting wire 114. The upper fruiting wire 114 supports foliage and grapes 116, for example, from the grapevines 106 growing in the vineyard. The lower drip line support wire 112 supports a drip line 118 at a height (e.g., 6 to 30 inches) above a surface 120 of the soil 110. The drip line 118 may be coupled to the drip line support wire 112 by a plurality of spaced apart drip line ties or fasteners 122 (see FIG. 4). The drip line 118 includes a plurality of emitters or drippers 124 spaced apart along a length of the drip line 118. The drip line 118 is fluidly coupled to a rising pipe 126, which in turn is coupled to a buried pipe 128 that is coupled to a water source 130. Although not shown for clarity, the underground irrigation system 100 may also include a number of pumps, water filters, fertigation systems, backflow prevention devices, pressure regulator, control valves, etc.

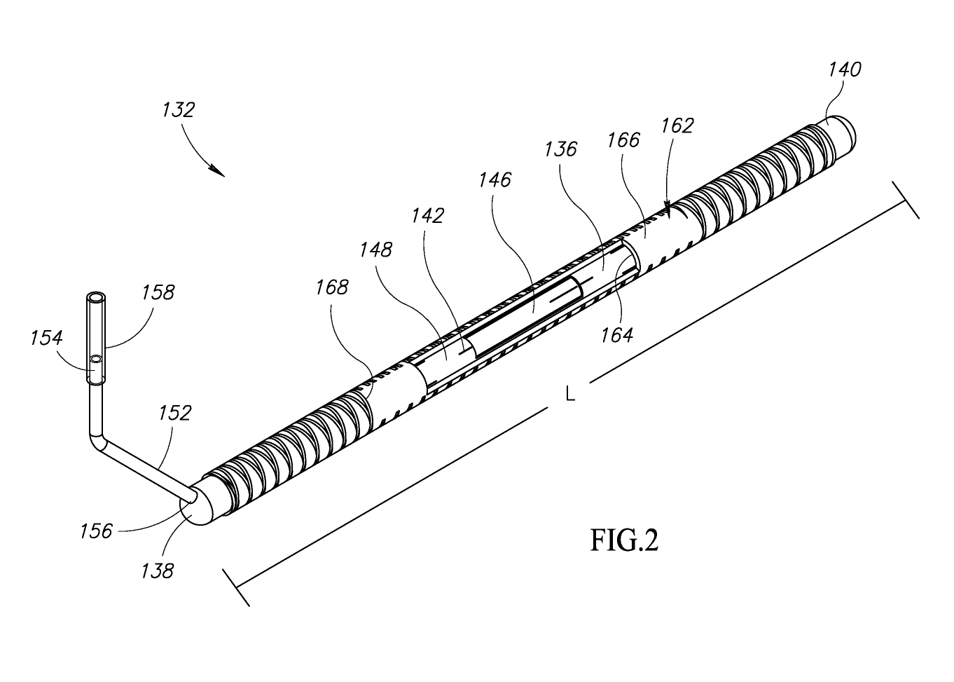

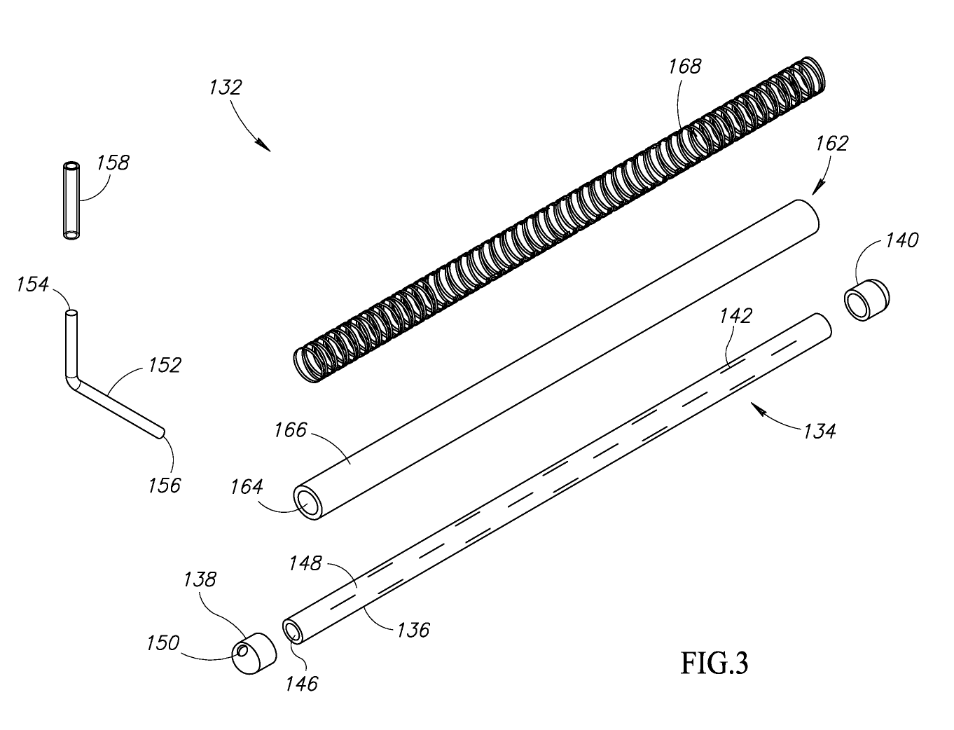

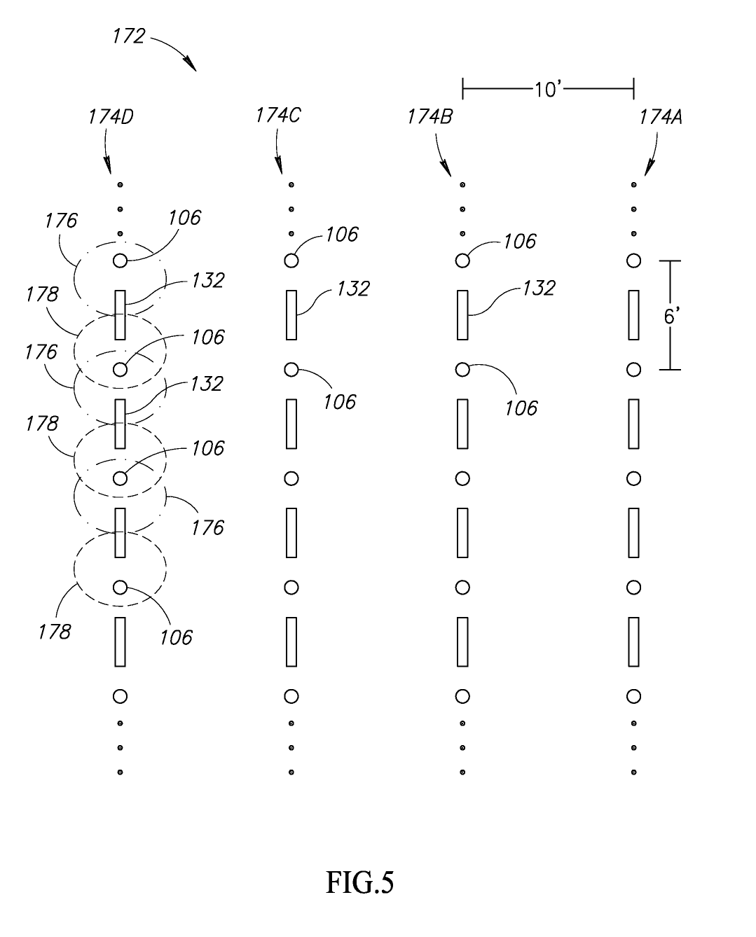

As may best be viewed in FIGS. 2-4, the underground irrigation system 100 includes a plurality of container or cartridge assemblies 132A-132D (generally, “cartridge assembly 132” or “cartridge assemblies 132”). Each of the cartridge assemblies 132 is installed in axial alignment between two adjacent grapevines 106 in a narrow trench 170 (see FIG. 4) at a depth of approximately 6 to 12 inches (e.g., 8 inches) below the surface 120 of the soil 110, so that each end of each cartridge assembly services roots 133 on one side of one of the two adjacent grapevines (see FIG. 5). Thus, there is approximately one cartridge assembly 132 for each of the grapevines 106.

As shown in FIGS. 2-4, the cartridge assembly 132 includes an elongated cartridge body 134 having a sidewall portion 136, a first end portion 138, and a second end portion 140 opposite the first end portion. The first end portion 138 and the second end portion 140 may be selectively attachable to the sidewall portion 136 or, in some implementations, may be integrally formed with the sidewall portion. The sidewall portion 136 may be, for example, a length of cylindrically shaped polyvinyl chloride (PVC) pipe. The length and diameter of the elongated cartridge body 134 may vary dependent on the particular application in which the cartridge body is to be used. For example, in some implementations the cartridge body 134 has a length (L) of between 12 inches and 48 inches (e.g., 36 inches) and a diameter of between 0.5 inches and 3 inches (e.g., 1 inch).

The sidewall portion 136 of the elongated cartridge body 134 includes a plurality of water distribution perforations 142 that each extend through the sidewall portion between an inner surface 144 of the sidewall portion to an outer surface 146 of the sidewall portion 136. In the illustrated example, the water distribution perforations 142 in the sidewall portion 136 are elongated axial slots spaced apart across the length of the sidewall and around the radius of the sidewall. The water distribution perforations 142 can take other shapes, sizes, and numbers, including circular shaped apertures, etc. The first end portion 138 of the elongated cartridge body 134 includes a water supply aperture 150.

The cartridge assembly 132 also includes a flexible feed tube 152 having a first end 154 and a second end 156. As shown in FIG. 4, the first end 154 of the flexible feed tube is coupleable to the emitter 124 of the aboveground irrigation system via a site tube 158 and an emitter coupling tube 160 to receive water from the emitter. In some implementations, the cartridge assembly 132 may be coupled to the aboveground irrigation system using more or fewer couplers. The second end 156 of the feed tube 152 is fluidly coupled to the water supply aperture 150 of the first end portion 138 of the elongated cartridge body 134 to supply water received from the emitter 124 to the elongated cartridge body 134. As shown in FIG. 4, a portion the feed tube 152, site tube 158, and/or the emitter coupling tube 160 may be fastened to a support (e.g., at least one of a stake 108 or a grapevine 106) via a fastener, such as a feed tube tie 123. In some implementations, the feed tube 152 is selectively coupleable to the emitter 124 via a non-fluid tight coupling (e.g., between the site tube 158 and the emitter coupling tube 160) to allow for true gravity delivery of water from the emitter to the feed tube, and thus to the elongated cartridge body 134.

The cartridge assembly 132 further includes a fluid dissipation layer in the form of a fluid-wicking mat 162 having an inner surface 164 and an outer surface 166. In some implementations the fluid-wicking mat 162 may be flexible and rectangular in shape such that the inner surface 164 of the fluid-wicking mat may be positioned adjacent to and surrounding the outer surface 148 of the sidewall portion 136 of the elongated cartridge body 134. Thus, the fluid-wicking mat 162 is in fluid communication with each of the plurality of water distribution perforations 142 in the sidewall portion 136 of the elongated cartridge body 134 such that water delivered to the elongated cartridge body via the feed tube 152 is absorbed by the fluid-wicking mat 162 and travels to the outer surface 166 of the fluid-wicking mat and into the surrounding soil 110. The fluid-wicking mat 162 may be formed from any suitable material that allows fluid (e.g., water) to dissipate therethrough. For example, in some implementations the fluid-wicking mat 162 is a fiberglass mat.

One or more strands of a wrapping material 168 are wound around the fluid-wicking mat 162 to secure the fluid-wicking mat to the elongated cartridge body 134. The wrapping material 168 may be formed from any suitable material. For example, in some implementations, the wrapping material 168 is fiberglass roving. In the illustrated example, the wrapping material 168 is wound around the fluid-wicking mat 162 in a double helix pattern, although other wrapping patterns (e.g., single helix pattern) may be used.

As shown best in FIG. 4, each cartridge assembly 132 may be buried in an elongated trench 170 between each pair of adjacent grapevines 106 that extend in a row. For example, the depth (DEPTH) of the trench 170 and thus the depth of the cartridge assembly 132 may be between about 6 inches to 12 inches (e.g., 8 inches). Each of the cartridge assemblies 132 may be centered between a pair of adjacent grapevines 106 that extend in a row. In some implementations, the first end portion 138 of the cartridge body may be proximate a first one of the two adjacent grapevines and separated therefrom by a distance (D) of between 18 inches and 24 inches, and the second end 140 may be proximate a second one of the two adjacent grapevines and separated therefrom by a distance (D) of between 18 inches and 24 inches.

FIG. 5 is a simplified schematic diagram that shows an example layout 172 for the cartridge assemblies 132 of the underground irrigation system 100 of FIG. 1 in a vineyard that includes four rows 174A-174D of grapevines 106. In the illustrated example, the rows 174A-174D are spaced apart from each other by approximately 10 feet, and the grapevines 106 are spaced apart from each other by approximately 6 feet within each row. Each of the cartridge assemblies 132 is installed in-line between two adjacent grapevines 106 in a row in a narrow trench 170 (see FIG. 4) at a depth of approximately 6 to 12 inches (e.g., 8 inches). As indicated by the dashed lines 176 and 178, each of the ends of each cartridge assembly 132 services one side of one of the two adjacent grapevines 106.

By utilizing the cartridge assemblies discussed herein, conversion of aboveground irrigation systems to underground irrigation systems for existing vineyards is simple. Only a narrow and shallow trench needs to be dug for each cartridge assembly between and in-line with each pair of the vines in a row. Thus, there is minimal damage to the existing root systems of the vines. Further, as discussed above, the elongated cartridge assemblies are long enough that one aboveground drip supply line services one side of two different vines (i.e., a total of one water supply line per vine), which allows use of existing drip irrigation water supply systems, thereby further offsetting the cost of conversion from an aboveground irrigation system to an underground irrigation system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of components, or virtually any combination thereof.

Those of skill in the art will recognize that many of the methods or algorithms set out herein may employ additional acts, may omit some acts, and/or may execute acts in a different order than specified.

The various embodiments described above can be combined to provide further embodiments. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An underground irrigation system for irrigating plants in a row of plants, the underground irrigation system comprising:
a plurality of independent cartridge assemblies, each of the cartridge assemblies including:
an elongated cartridge body having a length dimension that extends between a first cartridge body end portion and a second cartridge body end portion, the length dimension less than a distance between two adjacent plants in the row of plants, the cartridge body positionable below a surface of soil between the two adjacent plants in the row of plants such that a longitudinal axis of the cartridge body that extends in a direction of the length dimension is axially aligned with the two adjacent plants in the row of plants with the first cartridge body end portion relatively proximate a first one of the two adjacent plants to provide irrigation thereto and the second cartridge body end portion relatively proximate a second one of the two adjacent plants to provide irrigation thereto, the cartridge body having a sidewall that includes a plurality of perforations that extend between an inner surface of the sidewall to an outer surface of the sidewall, the cartridge body further includes a water supply aperture;
a feed tube having a first end and a second end, the first end of the feed tube coupleable to an aboveground irrigation system to receive water from the aboveground irrigation system, the second end of the feed tube coupled to the water supply aperture of the cartridge body; and
a fluid dissipation layer having an inner surface and an outer surface, the inner surface of the fluid dissipation layer positioned adjacent to and surrounding the outer surface of the sidewall of the cartridge body and in fluid communication with the perforations in the sidewall of the cartridge body.

2. The underground irrigation system of claim 1, further comprising:
a wrapping material wound around the fluid dissipation layer to secure the fluid dissipation layer to the cartridge body.

3. The underground irrigation system of claim 2 wherein the wrapping material comprises fiberglass roving.

4. The underground irrigation system of claim 2 wherein the wrapping material comprises one or more strands of material wound around the fluid dissipation layer in one of a single helix pattern or a double helix pattern.

5. The underground irrigation system of claim 1 wherein the first end of the feed tube is coupleable to an emitter of the aboveground irrigation system.

6. The underground irrigation system of claim 1 wherein the water supply aperture is positioned proximate one of the first cartridge body end portion or the second cartridge body end portion.

7. The underground irrigation system of claim 1 wherein the cartridge body comprises a cylindrically shaped polyvinyl chloride (PVC) pipe.

8. The underground irrigation system of claim 1 wherein the cartridge body is positionable at a depth of between 6 inches and 12 inches below the surface of the soil.

9. The underground irrigation system of claim 1 wherein the cartridge body has a length of between 12 inches and 48 inches.

10. The underground irrigation system of claim 1 wherein at least some of the perforations in the sidewall of the cartridge body comprise slots.

11. The underground irrigation system of claim 1 wherein the fluid dissipation layer comprises a fiberglass mat.

12. The underground irrigation system of claim 1 wherein the first end of the feed tube is selectively coupleable to the aboveground irrigation system via a non-fluid tight coupling.

13. A method of converting an aboveground irrigation system to an underground irrigation system, the method comprising:
providing a plurality of cartridge assemblies, each of the cartridge assemblies including:
a cartridge body having a sidewall that includes a plurality of perforations that extend between an inner surface of the sidewall to an outer surface of the sidewall, the cartridge body further includes a water supply aperture;
a feed tube having a first end and a second end, the second end of the feed tube coupled to the water supply aperture of the cartridge body;
a fluid dissipation layer having an inner surface and an outer surface, the inner surface of the fluid dissipation layer positioned adjacent to and surrounding the outer surface of the sidewall of the cartridge body and in fluid communication with the perforations in the sidewall of the cartridge body; and
a wrapping material wound around the fluid dissipation layer to secure the fluid dissipation layer to the cartridge body;
positioning a plurality of cartridge bodies in alignment with a row of plants at a determined depth below a surface of soil, each of the cartridge bodies disposed between a respective pair of adjacent plants in the row of plants; and
coupling the first end of the feed tube of each respective cartridge body to the aboveground irrigation system to receive water from the aboveground irrigation system.

14. The method of claim 13 wherein positioning the plurality of cartridge bodies in alignment with the row of plants comprises positioning each of the cartridge bodies between a respective pair of adjacent plants in the row of plants equidistant from each of the pair of adjacent plants.

15. The method of claim 13, further comprising:
digging a plurality of trenches in the soil in alignment with the row of plants at the determined depth below the surface of the soil, each of the trenches associated with one of the plurality of cartridge bodies and positioned between a respective pair of adjacent plants in the row of plants.

16. The method of claim 13 wherein digging a plurality of trenches comprises digging a plurality of trenches that each have a depth of between 6 inches and 12 inches.

17. The method of claim 13, further comprising:
fastening a portion of the feed tube to a support.

18. The method of claim 13 wherein coupling the first end of the feed tube to the aboveground irrigation system comprises coupling the first end of the feed tube to the aboveground irrigation system via a non-fluid tight coupling.

19. An underground irrigation system for irrigating two adjacent plants in a row of plants, the underground irrigation system comprising:
a cartridge body positionable below a surface of soil between the two adjacent plants in the row of plants, the cartridge body having a sidewall that includes a plurality of perforations that extend between an inner surface of the sidewall to an outer surface of the sidewall;
a feed tube having a first end and a second end, the first end of the feed tube coupleable to an emitter of an aboveground drip irrigation system to receive water from the emitter, the second end of the feed tube fluidly coupled to the cartridge body;
a fluid dissipation layer having an inner surface and an outer surface, the inner surface of the fluid dissipation layer surrounding at least a portion of the outer surface of the sidewall of the cartridge body; and
a wrapping material wound around the fluid dissipation layer to secure the fluid dissipation layer to the cartridge body.

20. The underground irrigation system of claim 19 wherein the wrapping material comprises fiberglass roving.

21. The underground irrigation system of claim 19 wherein the wrapping material comprises one or more strands of material wound around the fluid dissipation layer in one of a single helix pattern or a double helix pattern.

22. The underground irrigation system of claim 19 wherein the cartridge body has a length of between 12 inches and 48 inches.

23. The underground irrigation system of claim 19 wherein the fluid dissipation layer comprises a fiberglass mat.

24. The underground irrigation system of claim 19 wherein the first end of the feed tube is selectively coupleable to the aboveground irrigation system via a non-fluid tight coupling.
